(19) United States
(12) Patent Application Publication
(10) Pub. No.: US 2018/0188833 A1
(43) Pub. Date: Jul. 5, 2018

(54) PROTECTIVE SLEEVE FOR TOUCHSCREEN STYLUS

(71) Applicant: Griffin Technology, LLC, Irvine, CA (US)

(72) Inventor: Aaron Wierenga, Nashville, TN (US)

(21) Appl. No.: 15/397,587

(22) Filed: Jan. 3, 2017

(51) Int. Cl. G06F 3/0354; G06F 3/044

(52) U.S. Cl. CPC G06F 3/03545; G06F 3/044

(57) ABSTRACT

A protective sleeve for a stylus is disclosed. The sleeve is designed to provide protection to the stylus while also being capable of providing an enhanced gripping surface. The sleeve includes a tubular component that is tethered or leashed to a conductive cap assembly. The cap assembly includes a conductive touchscreen interface and is adapted to facilitate interaction with a capacitive touchscreen display. The cap assembly is configured to facilitate electrical coupling between the conductive touchscreen interface and the electrical ground circuitry of the stylus for which it is configured when the stylus is in the sleeve and is further adapted to being magnetically secured to the stylus. The conductive touchscreen interface may be formed of a polymer impregnated with conductive particles so as to provide suitable conductivity to interact with the electrostatic field a capacitive touchscreen display, yet avoid scratching display.

### BACKGROUND OF THE INVENTION

### Field of the Invention

This invention relates to accessories for electronic devices and more specifically to a protective sleeve for a touchscreen stylus.

### Description of the Related Art

Electronic devices, such as smart and cellular phones, computing tablets, MP3/audio/video players, gaming devices and laptops are continuously and rapidly evolving to meet expanding consumer demands. These days, such devices typically include user interactive capacitive touchscreens that are capable of interacting with a user's finger and/or capacitive stylus.

When a capacitive stylus is used, the stylus acts as a proxy to a user's finger to disrupt the touchscreen's electrostatic field. A discharge path between the screen and the stylus is formed, which results in a voltage drop at the point of contact with the screen. Some capacitive styluses may also include active sensors so as to enable enhanced touchscreen interactions. For example, they may detect the amount of pressure exerted by the user on the touchscreen and/or the angle/tilt of the stylus relative to the touchscreen and transmit such information to the electronic device over Bluetooth or other wireless or wired connection.

The Apple Pencil™, which includes pressure sensitivity and angle detection features, is one example of such an active capacitive stylus. Darker or lighter, bolder or thinner, and shaded or unshaded strokes in a drawing can be achieved depending on how hard the user presses the stylus against the capacitive touchscreen and how the user manipulates the relative angle of the stylus vis-à-vis the touchscreen. The Apple Pencil™ stylus, like other such styluses, has a cylindrically shaped, generally smooth and glossy finished, external housing. The external housing is a made of hard plastic. Residing within the hard plastic external housing is an internal metal shell/housing. Connectivity with the electronic device is via a built-in Bluetooth interface. Power is provided via a built-in rechargeable battery that can be recharged via a Lightning™ connector positioned on an opposing end of the stylus tip and protected under a removable magnetic metallic connector cap. The Lightening™ connector is electrically grounded to the rechargeable battery. Other than serving to protect the Lightning™ connector, the metallic connector cap of the Apple Pencil™ stylus is not functional in that it is not adapted to interact with a capacitive touchscreen (i.e., to disrupt the touchscreen's electrostatic field in an appropriate manner to create the requisite voltage drop in the touchscreen at the point of contact).

The inventor here, however, has recognized that the external surfaces of styluses, like the Apple Pencil™, can become slick with use due to sweat and/or oil from the user's hand, which may lead to user fatigue and may make it more difficult to effectuate agile motions or desired interaction with the touchscreen. Because such active styluses also house electronics and sensors to facilitate their operation, the inventor here has also recognized that such styluses can also be prone to damage as a result of impact or liquid intrusion. For example, a stylus may roll off a desk, slip or be otherwise dislodged from a person's hand and fall on a hard floor or surface thereby causing internal and/or external damage to the stylus. Alternatively, a user or office mate may inadvertently spill coffee or some other drink on or near the stylus, which may corrode or interfere with the proper functionality of the electronics and sensors. In addition, the inventor here has recognized that the end cap may be easily lost or misplaced, which may lead to damage to the lightening connector and lack of operability. Furthermore, the inventor here has recognized that while the touchscreen tip of the stylus is capable of implementing specific interactions with the touchscreen, its specific configuration may be limiting and/or insufficient to effectuate the full spectrum of a user's desired interactions with the touchscreen.

Accordingly, it is here recognized that there is a need for a stylus sleeve accessory that is capable of overcoming these shortcoming, including protecting the stylus from damage, and enhancing functionality.

### BRIEF SUMMARY OF THE INVENTION

Disclosed are numerous aspects of an unique and inventive stylus sleeve configured to receive, retain, protect and enhance the functionality of a stylus. Various aspects are described and/or illustrated in the drawings and the written specification including the claims herein and summarized here.

In one aspect, the stylus sleeve includes a tubular component and a tethered cap assembly, which is configured to interact with a capacitive touchscreen display. In another aspect, the tubular component is configured to receive and retain the stylus and provide an enhanced gripping surface that can mitigate damage to the stylus. In yet another aspect, the cap assembly includes conductive components that are arranged to interface with the electrical ground of the stylus and facilitate interaction with a capacitive touchscreen.

The configuration and construction of each of the components and sub components and their interrelationship constitute separate aspects.

Each of the foregoing and various aspects, together with those set forth in the claims and summarized above and/or otherwise disclosed herein, including the drawings, may be combined to support claims for a device, apparatus, system, method of manufacture, and/or use without limitation.

### BRIEF DESCRIPTION OF THE DRAWINGS

These and other features, aspects, and advantages are described below with reference to the drawings, which are intended to illustrate, but not to limit, the invention. In the drawings, like reference characters denote corresponding features consistently throughout the drawings.

FIG. 1 is a perspective view of a stylus sleeve configured to receive and retain a stylus in accordance with the teachings herein. The stylus sleeve depicted is specifically configured for an Apple Pencil™ stylus (not depicted in FIG. 1).

FIGS. 2A-2F are front side, back side, left side, right side, top end and bottom end views, respectively, of the stylus sleeve illustrated in FIG. 1.

FIG. 3 is a perspective view of the stylus sleeve of FIG. 1 with the Apple Pencil™ stylus inserted therein and the cap assembly in the closed position. The cap sleeve and magnet components of the stylus sleeve cap assembly are further illustrated separately to provide a more detailed depiction of those components.

FIG. 4 illustrates on the bottom side a partial cross sectional view of the stylus sleeve illustrated in FIG. 1, with the Apple Pencil™ stylus retained therein. The stylus sleeve cap assembly is in the closed position. On the top side, FIG. 4 illustrates a capacitive touchscreen display, such as the type used in a smart phone or computing tablet. The drawing is intended to show the interrelationship of the cap assembly components that form an electrical pathway from the capacitive touchscreen display through conductive touchscreen interface and the conductive cap sleeve to the Lightening™ connector of the Apple Pencil™ stylus, which thereby allows the stylus to serve as an electrical ground.

FIG. 5 illustrates how the conductive touchscreen interface of the cap assembly of the stylus sleeve illustrated in FIG. 1 can be used to interact with a capacitive touchscreen display of a tablet computing device to select performance of certain operations.

FIG. 6A is a perspective view of the conductive cap sleeve of the cap assembly of the stylus sleeve illustrated in FIG. 1. Illustrated in shadow in the drawing is the internal configuration of the conductive cap sleeve component including the notch configured to receive the Lightening™ connector of the Apple Pencil™ stylus.

FIG. 6B is a cross-sectional view of the illustration of FIG. 6A taken along the longitudinal mid-line.

FIG. 7A is a partial perspective view of the conductive cap sleeve component and magnet component of the stylus sleeve illustrated in FIG. 1 attached in the closed position to the Lightening™ connector of the Apple Pencil™ stylus. The drawing is intended to show the interrelationship between the conductive cap sleeve and magnet components vis-à-vis the Lightening™ connector when the cap assembly is attached to the Apple Pencil™ stylus. The Lightening™ connector of the Apple Pencil™ stylus and the internal configuration of the conductive cap sleeve are illustrated in shadow.

FIG. 7B is a cross-sectional view of the illustration of FIG. 7A taken along the longitudinal mid-line.

FIG. 8 illustrates how the conductive touchscreen interface of the cap assembly of the stylus sleeve illustrated in FIG. 1 can be used to interact as an eraser with a capacitive touchscreen display of a tablet computing device.

FIGS. 9A-9D illustrates the cap assembly of the stylus sleeve illustrated in FIG. 1 and a manner by which the cap assembly can be removed from the Lightening™ connector of the Apple Pencil™ stylus for which it is configured. FIG. 9A illustrates the cap assembly in a closed position over the Lightening™ connector of the Apple Pencil™ stylus, the cap assembly is being held by a user's fingers which are starting to twist the cap assembly counter-clockwise to begin to loosen the leash/tether. FIG. 9B illustrates cap assembly being further twisted approximately 45 degrees in the counter-clockwise direction to illustrate how the tether is further unwound. FIG. 9C shows that the cap assembly being further twisted to approximately 90 degrees in the counter-clockwise direction and how the tether is nearly completely unwound. FIG. 9D shows the cap assembly completely removed from the Lighting™ connector of the Apple Pencil™ stylus and dangling by tether from the tubular component of the stylus sleeve.

Each drawing is generally to scale and hence relative dimensions of the various layers can be determined from the drawings.

### DETAILED DESCRIPTION OF THE PREFERRED EMBODIMENT

As summarized above and illustrated in the drawings, disclosed herein are various aspects of a protective sleeve for a stylus. Many of those aspects are described and summarized above and illustrated in the drawings.

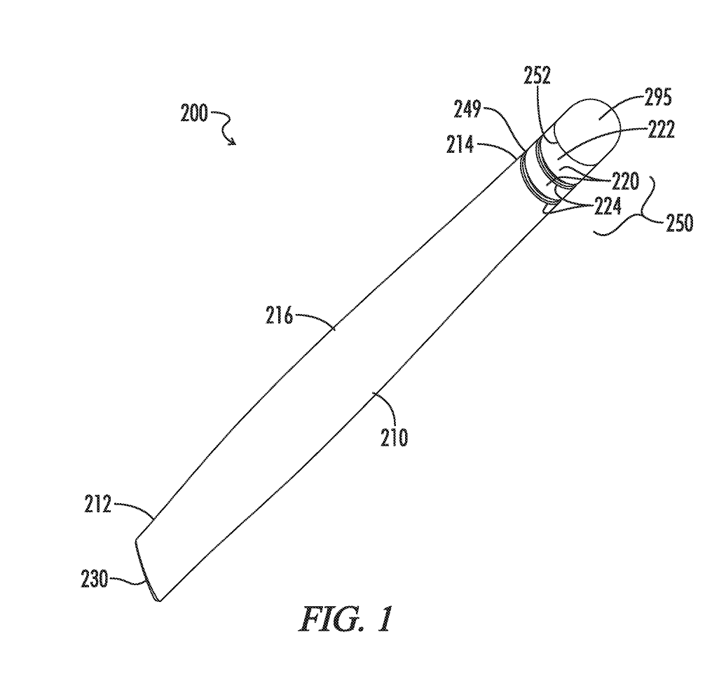

Commonly disclosed in FIGS. 1-9D is a stylus sleeve 200 configured to receive, retain and protect a stylus 100. The drawings individually and collectively illustrate, by way of example only, various of the configuration and construction aspects of the stylus sleeve 200. In this particular implementation, the stylus sleeve 200 is configured for an Apple Pencil™ stylus. It should be understood, however, that the stylus sleeve 200 may be configured for any stylus, including but not limited to other enhanced or active styluses configured to engage with capacitive touchscreen displays.

Styluses, like the Apple Pencil™ stylus, typically mimic a pencil in shape and include a cylinder-shaped body 110 with a touchscreen tip 120 on one end and a blunted end cap 130 on the opposite end. The end cap 130 serves to conceal and protect a power or electrical connector 140 (i.e., the Lightening™ connector on the Apple Pencil™ stylus), which is used to charge a rechargeable battery (not shown) that is housed within the body 110 of the stylus 100, Sensors (e.g., pressure and orientation/tilt sensors) and connectivity circuitry, such as a Bluetooth interface module, are also housed within the stylus body 110 and can provide enhanced functionality as previously described.

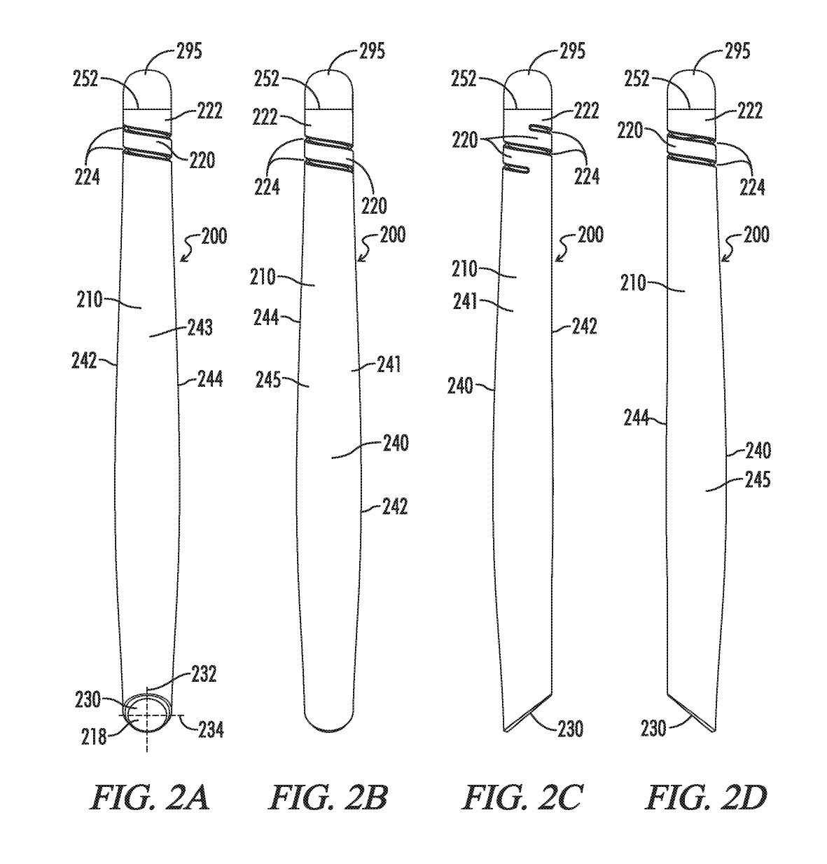

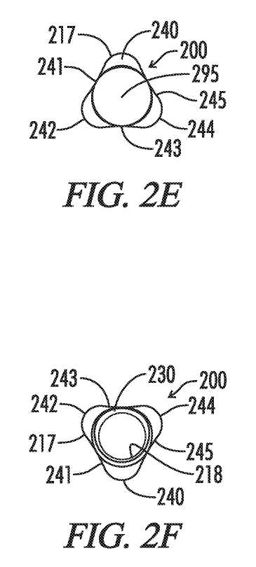

As best depicted in FIGS. 1-3 and 9A-9D, the stylus sleeve 200 includes a tubular component 210 that is connected at its upper end 249 via a tether 220 to a cap assembly 250 and at its lower portion 212 includes an elliptically shaped opening 230 (defined by major and minor axis 232, 234) through which the touchscreen tip 120 of the stylus 100 is configured to extend. As best illustrated in FIGS. 2C and 2D, elliptically shaped opening 230 that is oriented at about 45 degrees relative to longitudinal extending axis of the stylus sleeve 200. In use, the elliptical shaped opening 230 can be positioned so that it generally parallel to the touchscreen surface when the user's thumb, index and middle fingers are grasping the flat sides 241, 243, 245, respectively. The elliptical shaped opening 230 thus also provides the user with a visible means to determine the rotational orientation of the stylus 100, which will allow the user to grasp the stylus in a consistent manner to better effectuate the desired or a more consistent performance from the stylus 100.

The tubular component 210 is defined by exterior and interior surfaces 217, 218. The interior surface 218 of the tubular component 210 corresponds to the exterior dimensions of the stylus 100 and is configured to receive and retain the stylus 100, whereas the exterior surface 217 is configured to provide an enhanced gripping surface for the user and protection to the stylus. In the illustrated embodiment, the lower and upper portions 212, 214 of the exterior surface 217 of the tubular component 210 are round or circular in cross-section while the middle portion 216 of the exterior surface 217 is triangular in cross-section. The triangular cross-sectional shape is defined by three flat surfaces 241, 243, 245 that merge together at rounded corners 240, 242, 244. The flat sides are capable of keeping the stylus from rolling off a flat or inclined surface such as a tablet computing device or drafting table. While a triangular cross-sectional shape is disclosed, it should be understood that any polygonal cross-sectional shape (e.g., rectangular, square, quadrilateral, pentagon, hexagon, octagon, nonagon decagon, etc.), may be employed alone or in combination with curved, circular, or oval regions like at the corners are along one or more sides.

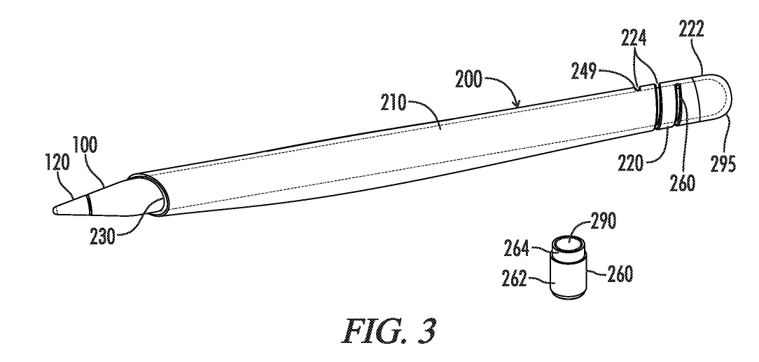

As best illustrated in FIG. 3, the tubular component 210 is thicker in diameter at its middle portion 216 that at either the upper or lower portions 214, 212. Such a configuration serves to elevate the end regions (i.e., the tip 120 and cap 130, which contains the electrical connector 140) of the stylus 100 above an underlying surface upon which the stylus 100 is resting or is dropped. Damaging impact and/or fluid ingress (such as that resulting from inadvertently spilled liquids) to those more sensitive end regions may thus be mitigated.

As depicted in the drawings, the exterior surface 217 of the tubular component 210 provides a gripping surface that is not only different in shape (e.g., triangular) but also greater in size from that of the underlying stylus 100 and thereby provides an increased gripping area relative to the underlying stylus 100. In the illustrated implementation, the exterior gripping surface of the stylus sleeve 200 is approximately 46 percent greater (+/−10 percent) than the underlying exterior circular gripping surface of the stylus (which surface area is the same as circular interior surface 218 of the tubular component). It should be understood that the area of the gripping surface of the stylus sleeve vis-à-vis the stylus may vary depending on the stylus and the desired exterior shape and dimensions of the stylus sleeve 200.

The tubular component 210 may be formed of any suitable material. The material may be softer, as rigid or more rigid than the underlying exterior surface of the stylus 100. The tubular component 210 may be formed as a unitary molded solid body or may be formed of multiple components, using multiple materials, and/or have hollow regions therein.

In one implementation, the tubular component 210 is formed as a flexible unitary solid molded polymer body. The tubular component 210, for example, may be formed of a molded composition of an elastomer to provide a soft yet durable gripping surface. Thermoplastic elastomer (TPE), natural or synthetic rubber, such as silicone (i.e., polysiloxane), or other similar polymers with a Shore A hardness of 65+/−20 have been found to provide a suitable yet durable gripping surface.

In other implementations, the tubular component 210 may be constructed to include regions (for example at the corners) that are formed of metallic or more rigid materials alone or that are imbedded or otherwise combined within a softer polymer such as one of the polymers disclosed herein. In yet other implementations, the tubular component 210 may be entirely formed of metallic or other rigid materials. In yet other implementations, the tubular component 210 may include a relatively rigid shell (e.g., formed of rigid plastic or a metal), which is entirely or partially overlaid on the interior and/or exterior surface with one or more softer, more pliable polymer or elastomer materials such as those described herein.

The cap assembly 250, which is connected to the tubular component 210 via tether 220, includes a hollow cap component 222, a conductive cap sleeve 260, a magnet 290, and a conductive touchscreen interface 295. The hollow cap component includes a lower end region 223 and an upper end region 225. The lower end region 223 of the hollow cap component 222 is tethered (via the cap tether 220) to the upper end section 249 of the tubular component 210. The upper end region 225 of the hollow cap component 222 is coupled to the conductive touchscreen interface 295 that mates with the upper rim 252 of the hollow cap component 222 to form the upper end region of the cap assembly 250.

The conductive touchscreen interface 295 is constructed to be sufficiently conductive to be capable of interacting with the capacitive touchscreen 310 of an electronic device and do so without scratching the touchscreen. In one implementation, the conductive touchscreen interface 295 is formed of a polymer impregnated with a conductive material such as carbon graphite, nickel, silver, copper, aluminum, tungsten, or other conductive materials or combinations thereof. Suitable materials from which the conductive touchscreen interface 295 may be constructed include but are not limited to the conductive particle filled elastomers set forth in the table 1 below.

TABLE 1
Conductive Particle Filled Elastomers

| | Material # | 1 | 2 | 3 | 4 |
|---|---|---|---|---|---|
| Elastomer | — | Silicone | Silicone | Silicone | Silicone |
| MIL-DTL-83528 TYPE | — | — | M | K | B |
| Conductive filler | — | Ni/Gr | Ag/Glass | Ag/Cu | Ag/Al |
| Volume resistivity | Ohm-cm | 0.100 | 0.006 | 0.005 | 0.008 |
| Hardness | Shore A | 30-70 | 65 | 85 | 65 |
| Operating Temp. | Deg. C. Min. | −55 | −55 | −45 | −55 |
| | Deg. C. Max. | 150 | 160 | 125 | 160 |
| | Material # | 5 | 6 | 7 | 8 |
| Elastomer | — | Fluorosilicone | Silicone | Silicone | Silicone |
| MIL-DTL-83528 TYPE | — | D | L | E | — |
| Conductive filler | — | Ag/Al | Ag/Ni | Ag | C (Graphite) |
| Volume resistivity | Ohm-cm | 0.012 | 0.005 | 0.002 | 7.000 |
| Hardness | Shore A | 70 | 75 | 65 | 70 |
| Operating Temp. | Deg. C. Min. | −55 | −55 | −55 | −55 |
| | Deg. C. Max. | 160 | 125 | 160 | 200 |
| | Material # | 9 | 10 | 11 | 12 |
| Elastomer | — | Silicone | Fluorosilicone | Fluorosilicone | Fluorosilicone |
| MIL-DTL-83528 TYPE | — | A | F | C | — |
| Conductive filler | — | Ag/Cu | Ag | Ag/Cu | Ni/Gr |
| Volume resistivity | Ohm-cm | 0.004 | 0.002 | 0.010 | 0.100 |
| Hardness | Shore A | 65 | 75 | 75 | 65 |
| Operating Temp. | Deg. C. Min. | −55 | −65 | −55 | −55 |
| | Deg. C. Max. | 125 | 160 | 125 | 150 |
| | Material # | 13 | 14 | 15 | 16 |
| Elastomer | — | Silicone | Fluorosilicone | Silicone | Silicone |
| MIL-DTL-83528 TYPE | — | I | — | H | G |
| Conductive filler | — | Ag | W/Al | Ag | Ag/Cu |
| Volume resistivity | Ohm-cm | 0.010 | 1.000 | 0.005 | 0.007 |
| Hardness | Shore A | 45 | 60-70 | 80 | 80 |
| Operating Temp. | Deg. C. Min. | −55 | −50 | −55 | −45 |
| | Deg. C. Max. | 160 | 200 | 160 | 125 |

When such conductive particle filled elastomers or polymers are used to form the conductive touchscreen interface 295, the conductive touchscreen interface 295 may be co-molded to the upper rim 252 of the hollow cap component 222. In such an implementation, the hollow cap component 222, tether 220, tubular component 210, and conductive touchscreen interface 295 could all be co-molded together as a unitary component. One polymer composition (e.g., silicone or elastomer), for example, may be used to form the tubular component 210, the tether 220, and the hollow cap component 222, while the conductive particle filled elastomer, such silicone impregnated with carbon graphite particles, may be co-molded thereto to form the conductive touchscreen interface 295.

Dimensionally, it has been found that the conductive touchscreen interface 295 performs more optimally when it is configured to include a circular interacting surface area that has a diameter of at least 3.5 mm and more preferably a diameter of at least 5 mm. The phrase “interacting surface area” as used herein is the surface area of the conductive touchscreen interface 295 that is configured to come into contact (at one time) with a flat capacitive touchscreen display 310.

The conductive cap sleeve 260 and magnet 290 components of the cap assembly 250 are best illustrated in FIGS. 3, 4, 6 and 7. The conductive cap sleeve 260 comprises an upper portion 264 and a lower portion 262. The upper portion 264 is configured to define a compartment dimensioned to receive the magnet 290. The lower portion 262 includes a cavity 263 configured to house, conceal, and protect the power or electrical connector 140 (i.e., the Lightening connector on the Apple Pencil™ stylus) of the stylus 100.

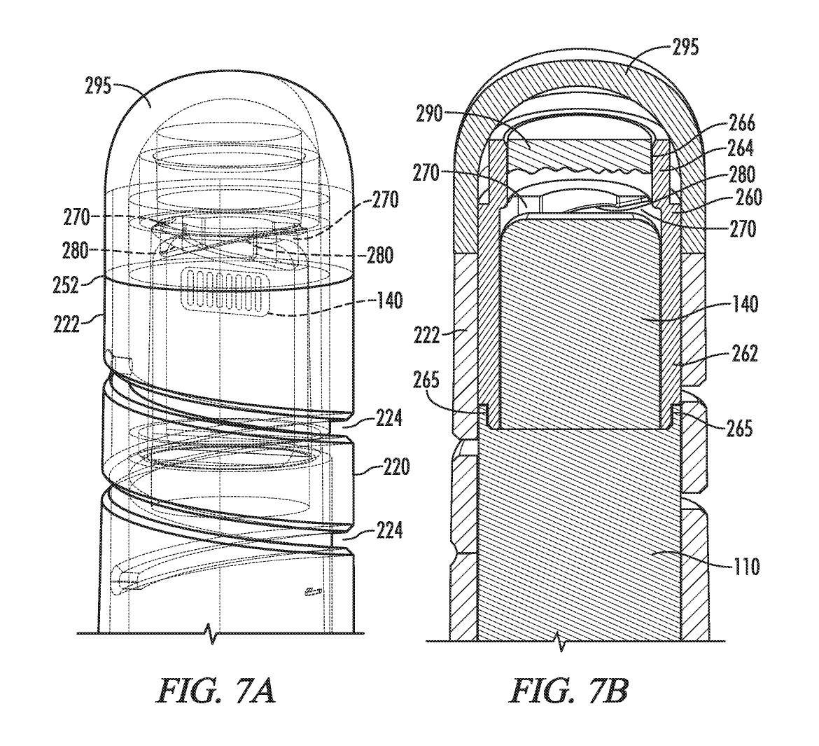

The cavity 263 of the lower portion 262 further includes a notched ceiling 270 at one end and a terminating interface 265 at the other end. The notched ceiling 270, as best illustrated in FIG. 7, is configured to receive and be in contact with the upper end of the lightening connector 140 when the cap assembly 150 is attached to the stylus 100 in the closed position.

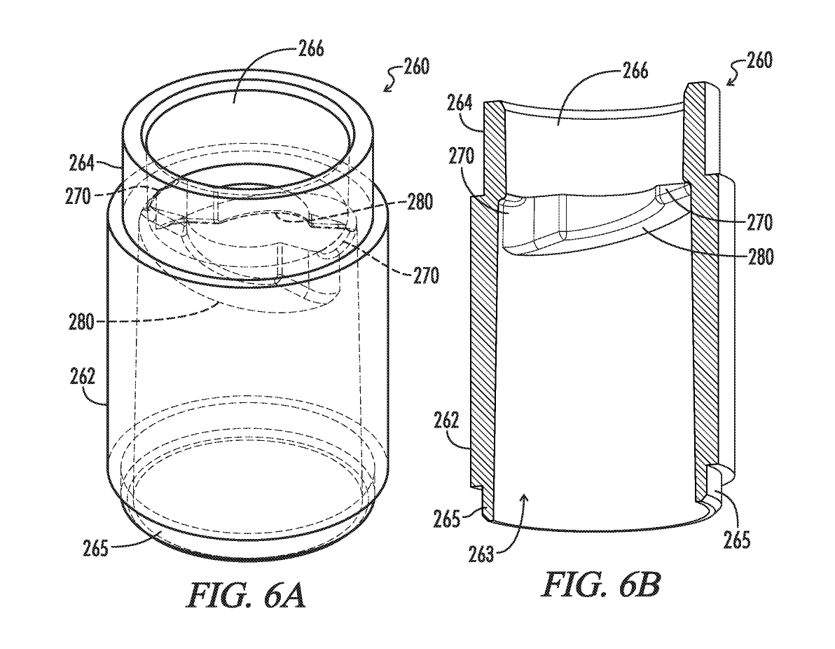

As best depicted in FIGS. 6 and 7, ramps 280 may also be provided in the notched ceiling 270 of the conductive sleeve 260 to assist or otherwise facilitate the seating of the Lightening connector 140 within the notch and may also serve to prevent the cap tether 220 from unwinding when the user is manipulating the stylus and sleeve, for example, when the user is rotating or dragging the conductive touchscreen interface 295 on a touchscreen 310 of the device 300 (e.g., as when performing an erasing function as illustrated in FIG. 8).

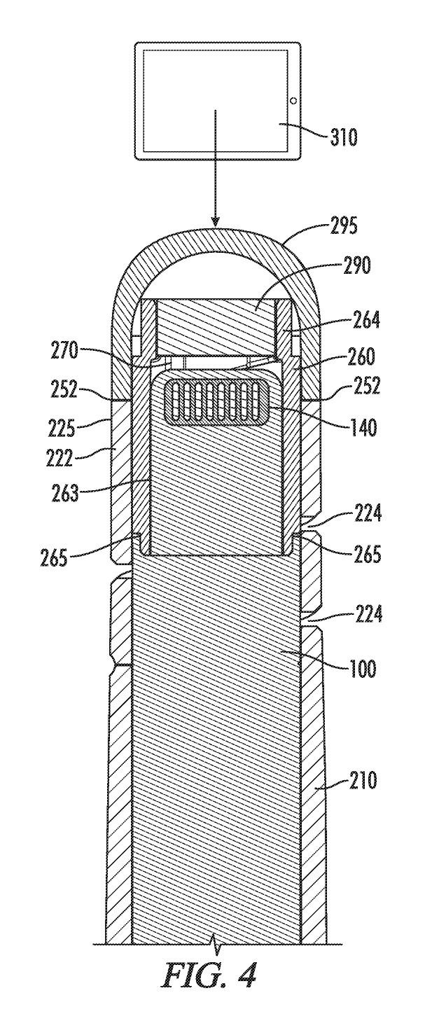

As best illustrated in FIG. 4, the conductive cap sleeve 260, when assembled with the other cap assembly components, is configured to reside within and in contact with the inner surface of the conductive touchscreen interface 295. In the illustrated embodiment both the upper portion 264 and at least a portion of the lower portion 262 of the conductive cap sleeve 260 are in contact with the inner surface of the conductive touchscreen interface 295. The notched ceiling 270 of the lower portion 262 of the conductive cap sleeve 260 is also configured to mate with the Lightening connector 140 of the stylus 100 and thereby provide an electrical pathway between the conductive touchscreen interface 295 and the stylus 100. Similarly, the terminating interface 265 is configured to engage and be in contact with the internal metal shell of the stylus 100 when the cap assembly 150 is in the closed position, which provides an additional conductive pathway between the conductive touchscreen interface 295 and the stylus 100.

The magnet 290 serves to retain engagement between the cap assembly 250 and the stylus 100. The magnet 290 is configured to generate sufficient magnetic attraction between the cap assembly 250 and the metallic portions of the stylus 100 located in and around the connector 140 so as to secure the cap assembly 250 thereto. Thus when the cap assembly 250 is in a closed position, the power connector 140 is protected from damage.

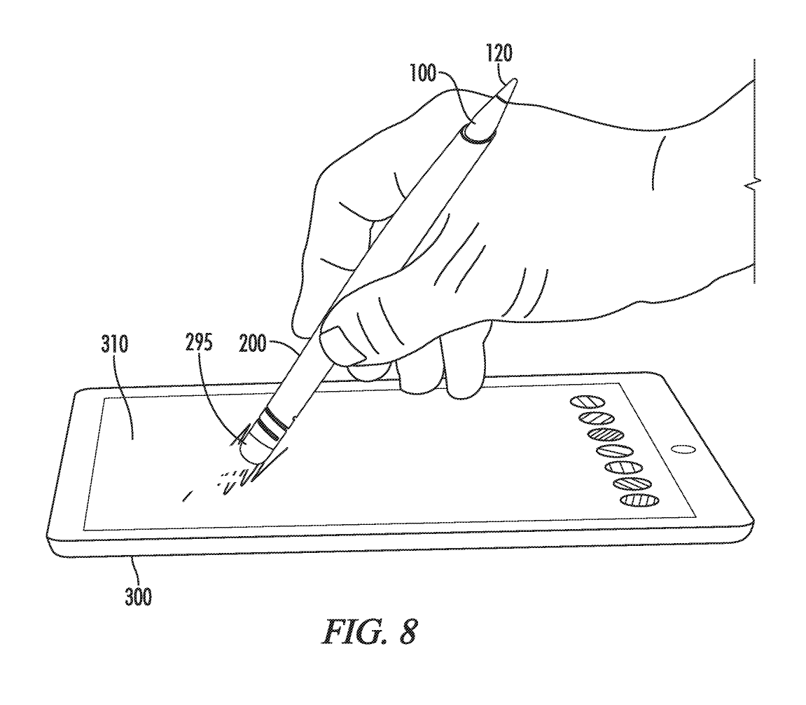

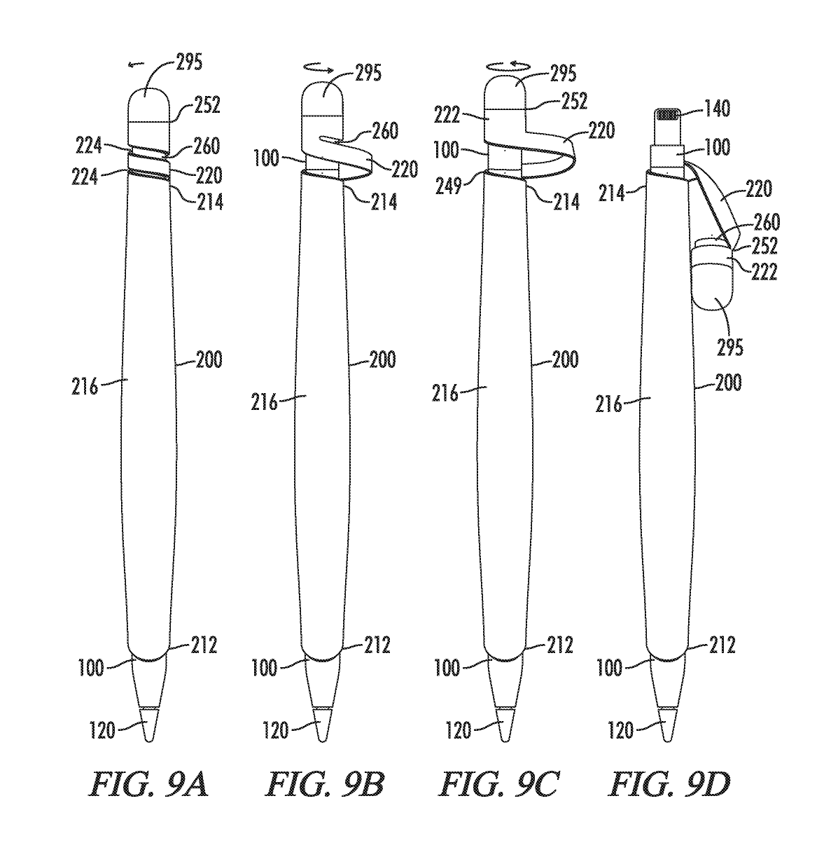

The tether 220 as best illustrated in FIGS. 2, 3 and 9 is configured to wrap around the stylus 100. In the illustrated implementation, a 720 degrees swirl partition 224 (is provided to separate the tether 220 from adjacent regions of the tether 220, the hollow cap compartment 222, and the upper portion 214 of the tubular component 210. As illustrated in FIGS. 9A-9D, wrapping the tether 220 in this manner facilitates removal of the cap assembly 250 from the stylus and allows the tether 220 to provide additional length so that the cap assembly 250 can be moved a sufficient distance away from the electrical connector 140 so as to avoid interference therewith during use. The tether 220 illustrated in the drawings, as previously noted, may be molded. When molded with a circular configuration, a natural bias toward its molded circular configuration is imparted. This natural bias is capable of urging the tether 220 to reside in close proximity to the stylus 100 and thereby provide a neat appearance when the cap assembly 250 is attached to the stylus in the closed positions such as illustrated in FIGS. 1-4, 5 and 8.

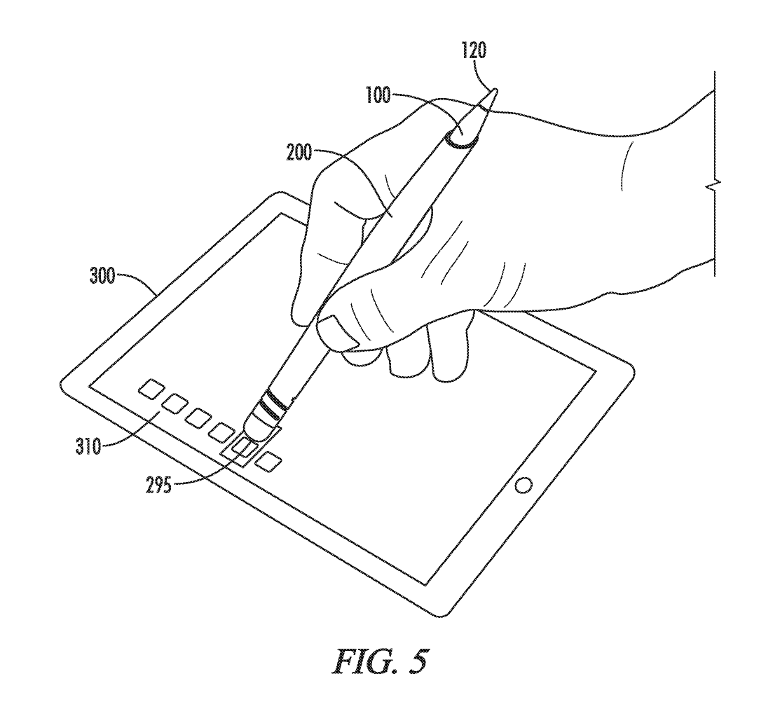

In operation, the user cleans the stylus 100 (e.g., with a dry cloth) then aligns the stylus in a desired or selected orientation relative to the stylus sleeve 200 (or elliptical opening 230) and pushes the stylus 100 into the tubular component 210 through the opening at the cap end until the stylus 100 is properly positioned with the stylus sleeve 200. In the example of Apple Pencil, proper alignment may be facilitated by aligning the “Pencil” marking shown on the connector 140 with the flat side 153. Once installed, the cap assembly 250 can be positioned over the connector 140 and within the notched ceiling 270 of the conductive sleeve. When properly installed, the leash or tether will lie smooth and flat around the conductive sleeve 260 of the cap assembly 250. Once installed with the cap assembly 250 in the closed position, the user can grip the stylus sleeve 200 and use the stylus tip 120 or, alternatively, the conductive touchscreen interface 295 provided on the opposite end of the stylus sleeve 200 to interact with a capacitive touchscreen display such as depicted in FIGS. 5 and 8. The user can remove the cap assembly 250 from the stylus to gain access to the charge connector 140 to recharge the stylus 100. The tether 220 prevents loss or misplacement of the of the cap assembly 250 when removed. As best depicted in FIGS. 9A-9D, removing of the cap assembly 250 from the stylus may accomplished by twisting the cap assembly 250 counter-clockwise thereby unraveling the tether 220 so as to provided additional slack in the tether 220 to allow for removal of the cap assembly 250. Once the cap assembly 250 is removed, the stylus 100 may be removed from the stylus sleeve 200 by gently pulling the stylus 100 from the elliptical opening 230 while holding the stylus sleeve 200.

Each of the foregoing and various aspects, or teachings herein together with those set forth in the claims and described in connection with the stylus sleeve described and summarized above or otherwise disclosed herein including the drawings may be combined to form claims for a device, apparatus, system, method of manufacture, and/or use without limitation.

Although the various inventive aspects are herein disclosed in the context of certain preferred embodiments, implementations, and examples, it will be understood by those skilled in the art that the present invention extends beyond the specifically disclosed embodiments to other alternative embodiments and/or uses of the invention and obvious modifications and equivalents thereof. In addition, while a number of variations of the various aspects have been shown and described in detail, other modifications, which are within their scope will be readily apparent to those of skill in the art based upon this disclosure. It should therefore be also understood that the scope of this disclosure includes the various combinations or sub-combinations of the specific features and aspects of the embodiments disclosed herein, such that the various features, modes of implementation, and aspects of the disclosed subject matter may be combined with or substituted for one another. Thus, it is intended that the scope of the present invention herein disclosed should not be limited by the particular disclosed embodiments or implementations described above, but should be determined only by a fair reading of claims made in this patent document and any future patent document that relies on this disclosure.

Similarly, this method of disclosure, is not to be interpreted as reflecting an intention that any claim require more features than are expressly recited in that claim. Rather, as the following claims represent, inventive aspects lie in a combination of fewer than all features of any single foregoing disclosed embodiment. Thus, the claims following the Detailed Description are hereby expressly incorporated into this Detailed Description, with each claim standing on its own as a separate embodiment.

What is claimed is:

1. A protective sleeve for a capacitive touchscreen stylus having a pencil shaped body extending from a stylus tip on one end and a power connector on a second end, said sleeve comprising:
a longitudinally extending tubular component extending from a top end region to a bottom end region and being configured to reversibly receive and retain the stylus, the bottom end region including a first opening and the top end region including a second opening; and
a conductive cap assembly comprising a conductive touchscreen interface component, a conductive sleeve component in contact with said conductive touchscreen interface component, and a non-conductive cap compartment that houses the conductive sleeve on one side and is in contact with the conductive touchscreen interface on a second side, wherein said conductive cap assembly is configured to be reversibly attached to the second end of the stylus.

2. The protective sleeve of claim 1, wherein said conductive cap assembly is tethered to the top end region of the tubular component.

3. The protective sleeve of claim 1, wherein said conductive cap assembly is configured to be capable of electrical interfacing with a capacitive touchscreen display when the stylus is inserted within the protective sleeve with the tip of the stylus extending through the first opening.

4. The protective sleeve of claim 1, wherein said conductive cap assembly is configured to be magnetically coupled to conductive regions of the stylus when the stylus is inserted within the protective sleeve with the tip of the stylus extending through the first opening.

5. The protective sleeve of claim 1, wherein said conductive touchscreen interface component and said conductive sleeve form an electrical pathway between the electrostatic field of a capacitive touchscreen display and ground circuitry of the stylus when the stylus is inserted within the protective sleeve with the tip of the stylus extending through the first opening.

6. The protective sleeve of claim 5, wherein said conductive sleeve is in contact with the electrical connector of said stylus when the stylus is inserted within the protective sleeve with the tip of the stylus extending through the first opening.

7. The protective sleeve of claim 1, wherein said non-conductive cap compartment is tethered to the tubular component.

8. The protective sleeve of claim 1, wherein said conductive touchscreen interface component is formed of a polymer impregnated with conductive particles.

9. The protective sleeve of claim 1, wherein said conductive touchscreen interface is a formed of an elastomer composition impregnated with conductive particles formed of material selected from a group consisting of carbon graphite, nickel, silver, copper, aluminum, and tungsten.

10. The protective sleeve of claim 1, wherein said conductive touchscreen interface, tubular component, non-conductive cap compartment, and a tether attaching said tubular component to said non-conductive cap compartment are formed as a unitary structure.

11. The protective sleeve of claim 1, wherein said conductive touchscreen interface, tubular component, non-conductive cap compartment, and a tether attaching said tubular component to said non-conductive cap compartment are formed of co-molded polymer materials as a unitary structure.

12. The protective sleeve of claim 11, wherein said tubular component, non-conductive cap compartment, and tether are constructed of the same polymer material.

13. The protective sleeve of claim 12, wherein said conductive touchscreen interface is formed of a polymer impregnated with carbon graphite particles.

14. The protective sleeve of claim 1, wherein said conductive sleeve is formed of metal and houses a magnetic element in a first portion and includes a notched compartment on a second portion.

15. The protective sleeve of claim 1, wherein said tubular component includes an interior surface and an exterior surface, the interior surface defines a cavity that is configured to receive and retain the stylus and the exterior surface defines a surface having one or more flat sides.

16. The protective sleeve of claim 15, wherein said tubular component has an exterior surface that is polygonal in shape.

17. The protective sleeve of claim 16, wherein said tubular component has an exterior surface that is triangular in shape.

18. The protective sleeve of claim 1, wherein said tubular component is formed of an elastomer material.

19. The protective sleeve of claim 1, wherein said tubular component is formed of material comprising silicone.

20. The protective sleeve of claim 1, wherein said first opening is elliptical in shape.

21. The protective sleeve of claim 1, wherein said conductive touchscreen interface is defined by an external surface, said external surface includes a circular surface having a diameter of at least 3.5 millimeters that is configured to engage a flat touchscreen display at the same time.

22. The protective sleeve of claim 1, wherein said conductive touchscreen interface is defined by an external surface, said external surface includes a circular surface having a diameter of at 5 millimeters+/−1.5 millimeters that is configured to engage a flat touchscreen display at the same time.
